(19) United States
(12) Patent Application Publication
(10) Pub. No.: US 2023/0370261 A1
(43) Pub. Date: Nov. 16, 2023

(54) COMPARISON SYSTEM, COMPARISON METHOD AND COMPUTER READABLE MEDIUM

(71) Applicant: NEC Corporation, Minato-ku, Tokyo (JP)

(72) Inventors: Masahiro NARA, Tokyo (JP); Toshihiko Okumura, Tokyo (JP); Toshiyuki Isshiki, Tokyo (JP); Hiroto Tamiya, Tokyo (JP)

(73) Assignee: NEC Corporation, Minato-ku, Tokyo (JP)

(21) Appl. No.: 18/031,096

(22) PCT Filed: Oct. 21, 2020
(86) PCT No.: PCT/JP2020/039598

§ 371 Date: Apr. 10, 2023

(51) Int. Cl. H04L 9/08; H04L 9/32

(52) U.S. Cl. CPC H04L 9/0869; H04L 9/0825; H04L 9/3231

(57) ABSTRACT

A comparison system includes a key generation means for generating a common key being common to each of a plurality of pieces of registration information, and also generating a plurality of unique keys being unique for each of the plurality of pieces of registration information by using a plurality of pieces of identification information, a concealment means (126) for generating a plurality of pieces of concealment information. The client includes a concealment index calculation means for calculating a plurality of concealment indexes representing a similarity degree between comparison information and each of the plurality of pieces of concealment information. The verification server includes a determination means for generating a plurality of indexes acquired by decrypting each of the plurality of concealment indexes, and also performing authentication of the comparison information, based on whether any of the plurality of indexes indicates a value within a predetermined range.

### TECHNICAL FIELD

The present invention relates to a comparison system, a comparison method, and a computer readable medium.

### BACKGROUND ART

One example of authentication is biometric authentication. The “biometric authentication” is a technique of personal authentication for confirming whether a registrant and an authenticated subject coincide with each other by comparing biometric information about the registrant with biometric information about the authenticated subject. Further, the “biometric information” is data being extracted from a part of features related to a body and behavior, or data being generated by converting the extracted data. The data may also be referred to as a feature value. Herein, data that include data generated by biometric information (hereinafter referred to as registration information) about a registrant and are stored in advance for biometric authentication are referred to as a template.

When biometric authentication is performed by a client-server system, there are an aspect in which a template is stored in a client and an aspect in which the template is stored in a server.

Patent Literature 1 and Patent Literature 2 describe one example of an authentication device and an authentication method in which registration information does not leak out by storing encrypted registration information as a template in a server.

Further, Patent Literature 3 describes a comparison system for increasing safety related to a binary vector.

Furthermore, Patent Literature 4 describes one example of an authentication device and an authentication method in which registration information does not leak out by storing encrypted registration information as a template in a client. By storing encrypted registration information as a template in a client, damage at occurrence of data leakage can be further reduced than when the encrypted registration information is stored in a server.

### CITATION LIST

### Patent Literature

[Patent Literature 1] Japanese Unexamined Patent Application Publication No. 2011-211593
[Patent Literature 2] Japanese Unexamined Patent Application Publication No. 2009-129292
[Patent Literature 3] International Patent Publication No. WO2018/110608
[Patent Literature 4] International Patent Publication No. WO2020/121458

### SUMMARY OF INVENTION

### Technical Problem

Biometric authentication includes an authentication form (hereinafter described as 1:N authentication) for confirming whether there is a coincidence by comparing N (N is an integer of one or more) templates with biometric information about an authenticated subject. In the 1:N authentication, for example, a method of repeating, for N times, an authentication form (hereinafter described as 1:1 authentication) for confirming by comparing one template with biometric information about an authenticated subject is conceivable. However, in this method, there is a problem that a communication amount, a calculation amount, and a stored data amount of a client and a server are N times those of the 1:1 authentication, and efficiency is further reduced with a greater value of N.

The present disclosure has been made in order to solve such a problem, and an object of the present disclosure is to provide a comparison system, a comparison method, and a computer readable medium that have efficient 1:N authentication.

### Solution to Problem

A comparison system according to the present disclosure includes: a common random number generation means for generating a common random number; an identification information generation means for generating a plurality of pieces of identification information being unique for each of a plurality of pieces of registration information being a plurality of pieces of biometric information about a plurality of registrants; a key generation means for generating a common key being common to each of the plurality of pieces of registration information by using the common random number, and also generating a plurality of unique keys being unique for each of the plurality of pieces of registration information by using the plurality of pieces of identification information; a concealment means for generating a plurality of pieces of concealment information in which each of the plurality of pieces of registration information is concealed by using the common key and the plurality of unique keys; a client; and a verification server, wherein the client includes a concealment index calculation means for calculating a plurality of concealment indexes representing a similarity degree between comparison information being biometric information about an authenticated subject, and each of the plurality of pieces of concealment information, and the verification server includes a determination means for generating a plurality of indexes acquired by decrypting each of the plurality of concealment indexes by using the common key and the plurality of unique keys, and also performing authentication of the comparison information, based on whether any of the plurality of indexes indicates a value within a predetermined range.

A comparison method according to the present disclosure includes: a common random number generation step of generating a common random number; an identification information generation step of generating a plurality of pieces of identification information being unique for each of a plurality of pieces of registration information being a plurality of pieces of biometric information about a plurality of registrants; a key generation step of generating a common key being common to each of the plurality of pieces of registration information by using the common random number, and also generating a plurality of unique keys being unique for each of the plurality of pieces of registration information by using the plurality of pieces of identification information; a concealment step of generating a plurality of pieces of concealment information in which each of the plurality of pieces of registration information is concealed by using the common key and the plurality of unique keys; in a client, a concealment index calculation step of calculating a plurality of concealment indexes representing a similarity degree between comparison information being biometric information about an authenticated subject, and each of the plurality of pieces of concealment information; and, in a verification server, a determination step of generating a plurality of indexes acquired by decrypting each of the plurality of concealment indexes by using the common key and the plurality of unique keys, and also performing authentication of the comparison information, based on whether any of the plurality of indexes indicates a value within a predetermined range.

A non-transitory computer readable medium according to the present disclosure stores a comparison program causing a computer to execute: common random number generation processing of generating a common random number; identification information generation processing of generating a plurality of pieces of identification information being unique for each of a plurality of pieces of registration information being a plurality of pieces of biometric information about a plurality of registrants; key generation processing of generating a common key being common to each of the plurality of pieces of registration information by using the common random number, and also generating a plurality of unique keys being unique for each of the plurality of pieces of registration information by using the plurality of pieces of identification information; concealment processing of generating a plurality of pieces of concealment information in which each of the plurality of pieces of registration information is concealed by using the common key and the plurality of unique keys; in a client, concealment index calculation processing of calculating a plurality of concealment indexes representing a similarity degree between comparison information being biometric information about an authenticated subject, and each of the plurality of pieces of concealment information; and, in a verification server, determination processing of generating a plurality of indexes acquired by decrypting each of the plurality of concealment indexes by using the common key and the plurality of unique keys, and also performing authentication of the comparison information, based on whether any of the plurality of indexes indicates a value within a predetermined range.

### Advantageous Effects of Invention

The present disclosure is able to provide a comparison system, a comparison method, and a computer readable medium that have efficient 1:N authentication.

### BRIEF DESCRIPTION OF DRAWINGS

FIG. 1 is a block diagram illustrating a configuration example of a comparison system according to a first example embodiment;

FIG. 2 is a block diagram illustrating a configuration example of a comparison system according to a second example embodiment;

FIG. 3 is a flowchart illustrating a generation operation of a common random number in the comparison system illustrated in FIG. 2;

FIG. 4 is a flowchart illustrating an operation of registration processing and authentication processing in the comparison system illustrated in FIG. 2;

FIG. 5 is a block diagram illustrating a first application example of the comparison system illustrated in FIG. 2;

FIG. 6 is a block diagram illustrating a second application example of the comparison system illustrated in FIG. 2; and

FIG. 7 is a block diagram illustrating an outline of a computer that achieves a client and a server to which the comparison systems according to the first and second example embodiments are applied.

### EXAMPLE EMBODIMENT

Hereinafter, example embodiments of the present disclosure will be described in detail with reference to drawings. In each of the drawings, the same or corresponding elements will be denoted by the same reference signs, and duplicate description will be omitted depending on need for the sake of clarity of explanation.

Note that, in the following description, an example in which a comparison system according to the present disclosure is applied to biometric authentication will be described, but the comparison system is not limited thereto and may be applied to authentication other than the biometric authentication or comparison processing.

### First Example Embodiment

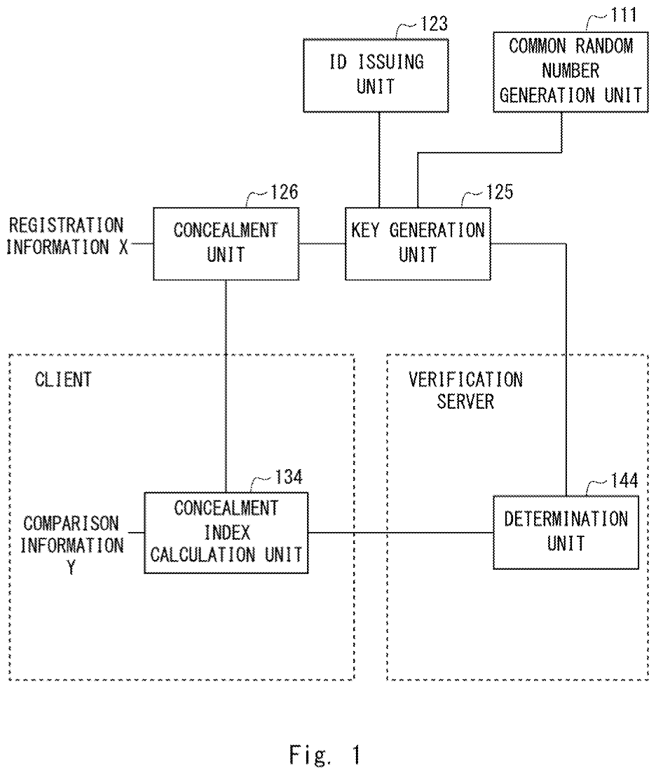

FIG. 1 is a block diagram illustrating an outline of a comparison system according to a first example embodiment.

The comparison system according to the first example embodiment includes a common random number generation unit 111, an ID issuing unit 123, a key generation unit 125, a concealment unit 126, a concealment index calculation unit 134, and a determination unit 144. Note that the concealment index calculation unit 134 is provided in a client. The determination unit 144 is provided in a verification server.

The common random number generation unit 111 generates a common random number CR when a start signal is input. The ID issuing unit 123 issues identification (ID) for each piece of biometric information (hereinafter described as registration information) X about a registrant. The key generation unit 125 generates a concealment key sk_ID being unique for each ID by using the input common random number CR. The concealment unit 126 conceals the registration information X by the concealment key sk_ID for each piece of the registration information X. The concealment unit 126 transmits, as a template, information (hereinafter described as concealment information) in which the plurality of pieces of registration information X are concealed to the client.

In the client, the concealment index calculation unit 134 calculates, based on a plurality of the templates (i.e., the concealment information acquired by concealing the registration information X) and comparison information Y (biometric information about an authenticated subject being used for a comparison with the registration information X), data (hereinafter described as a concealment index) in which an index being a value indicating similarity between each of the plurality of pieces of registration information X and the comparison information Y is concealed, and transmits a plurality of the calculated concealment indexes to the verification server.

In the verification server, the determination unit 144 acquires the plurality of concealment indexes being transmitted from the client. Then, the determination unit 144 first generates a plurality of indexes acquired by decrypting each of the plurality of concealment indexes by using a common key CR and the plurality of concealment keys sk_ID being unique for each ID. Subsequently, the determination unit 144 performs 1:N authentication by determining whether any of the plurality of decrypted indexes has a value within a predetermined acceptance range. Only when one index within the acceptance range is present, the determination unit 144 transmits, to the client, an ID and authentication result information indicating that the authentication succeeds (the authentication is accepted). In contrast, when the index within the acceptance range is not present or when the plurality of indexes within the acceptance range are present, the determination unit 144 transmits, to the client, authentication result information indicating that the authentication fails.

For example, when the client receives the authentication result information indicating that the authentication succeeds from the verification server, the client performs processing after the authentication being associated with the ID. However, a device that performs the processing after the authentication is not limited to the client, and a device other than the client may perform the processing after the authentication being associated with the ID on a condition that the authentication result information indicating that the authentication succeeds is acquired.

In this way, the comparison system according to the first example embodiment makes some of concealment keys used for generating each template uniform, and can thus reduce the number of pieces of data being held by the client and the number of keys being held by the verification server and reduce the number of times of exponentiation and a communication amount of the client and the verification server, as compared to when some of concealment keys are not made uniform. In other words, the comparison system according to the first example embodiment can perform efficient 1:N authentication.

Note that, in the comparison system according to the first example embodiment, encrypted registration information is stored as a template in the client, and thus damage at occurrence of data leakage can be further reduced than when the encrypted registration information is stored in the server. In other words, the comparison system according to the first example embodiment can perform efficient 1:N authentication while improving security performance.

### Second Example Embodiment

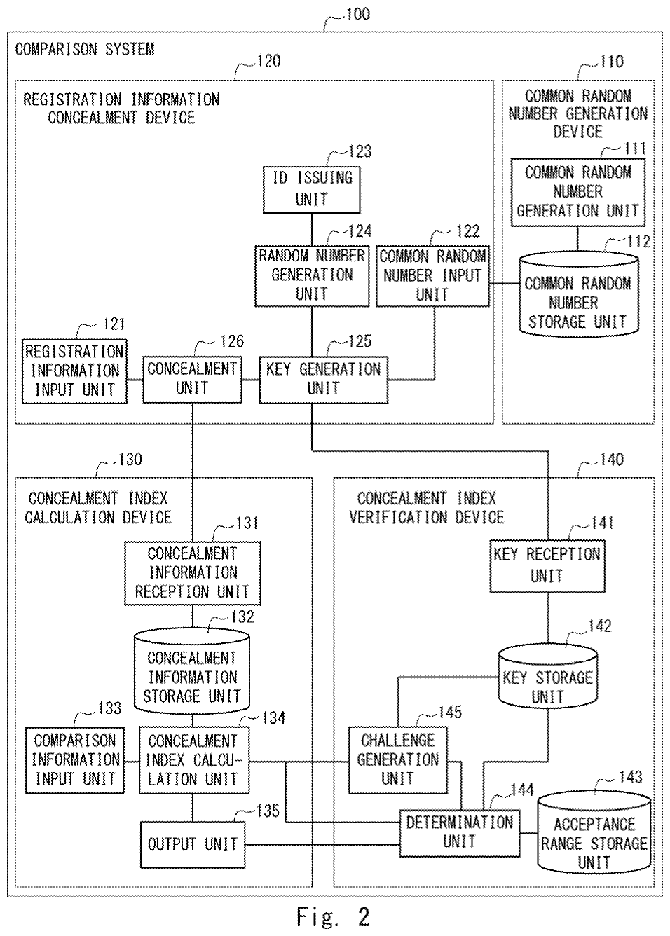

FIG. 2 is a block diagram illustrating a configuration example of a comparison system 100 according to a second example embodiment. The comparison system 100 illustrated in FIG. 2 is a block diagram more specifically illustrating the comparison system illustrated in FIG. 1.

As illustrated in FIG. 2, the comparison system 100 includes a common random number generation device 110, a registration information concealment device 120, a concealment index calculation device 130, and a concealment index verification device 140.

Note that, in the present example embodiment, a case where registration information and comparison information are represented by a common dimensional vector is described as an example. Further, in the present example embodiment, biometric information may be extracted from an iris, a retina, a face, a blood vessel (vein), a palm print, a voice print other than a fingerprint, or a combination thereof. Alternatively, biometric information may be extracted from other information that can identify a living body other than the examples described above.

### (Configuration of Common Random Number Generation Device 110)

The common random number generation device 110 includes a common random number generation unit 111 and a common random number storage unit 112. The common random number generation device 110 generates a common random number CR. The common random number generation unit 111 generates the common random number CR when a start signal is input. The common random number storage unit 112 stores the common random number CR being generated by the common random number generation unit 111. The common random number CR being generated by the common random number generation device 110 is used in the registration information concealment device 120.

### (Configuration of Registration Information Concealment Device 120)

The registration information concealment device 120 includes a registration information input unit 121, a common random number input unit 122, an ID issuing unit 123, a random number generation unit 124, a key generation unit 125, and a concealment unit 126.

The registration information input unit 121 accepts an input of biometric information (hereinafter described as registration information) X about a registrant. The registration information input unit 121 may be an input device according to a kind of the registration information X. For example, when biometric information extracted from a fingerprint is the registration information X, the registration information input unit 121 may be an input device that reads the fingerprint, extracts a vector to be biometric information about a registrant from the fingerprint, and accepts the vector as the registration information X. Further, the registration information input unit 121 may be an input device to which a vector to be biometric information about a registrant is directly input as the registration information X.

The common random number input unit 122 accepts the common random number CR from the common random number generation device 110. The common random number input unit 122 outputs the accepted common random number CR to the key generation unit 125. The ID issuing unit 123 issues an ID each time the registration information X is input to the registration information input unit 121. The random number generation unit 124 generates a random number R_ID for each issued ID. Input is made to the random number R_ID being generated by the random number generation unit 124.

The key generation unit 125 generates a concealment key by using the common random number CR and the random number R_ID. Herein, the present example embodiment adopts a digital signature based on a public key cryptosystem. Thus, the key generation unit 125 generates a public key pk and a secret key sk of the digital signature by using the common random number CR. Note that the secret key sk is also used as a concealment key. Further, the key generation unit 125 generates a common concealment key sk_C by using the common random number CR, and also generates a concealment key sk_ID for each piece of the registration information X by using the common random number CR and the random number R_ID. The key generation unit 125 outputs, to the concealment unit 126, the secret key sk, the common concealment key sk_C, and the concealment key sk_ID for each piece of the registration information X. Further, the key generation unit 125 transmits, to the concealment index verification device 140, the public key pk, the common concealment key sk_C, and the concealment key sk_ID for each piece of the registration information X.

The concealment unit 126 conceals the registration information X input to the registration information input unit 121 by using the secret key sk, the common concealment key sk_C, and the concealment key sk_ID associated with the registration information X. The concealment unit 126 transmits information (hereinafter described as concealment information) in which the registration information X is concealed to the concealment index calculation device 130.

The common random number input unit 122, the key generation unit 125, and the concealment unit 126 are achieved by, for example, a central processing unit (CPU) of a computer operating according to a client program and a communication interface of the computer. For example, the CPU may read the client program from a program recording medium such as a program storage device of the computer, and operate as the common random number input unit 122, the key generation unit 125, and the concealment unit 126 by using the communication interface according to the program. Further, the ID issuing unit 123 and the random number generation unit 124 are achieved by, for example, the CPU of the computer that operates according to the client program. For example, the CPU may read the client program from the program recording medium as described above, and operate as the ID issuing unit 123 and the random number generation unit 124 according to the program.

### (Configuration of Concealment Index Calculation Device 130)

The concealment index calculation device 130 includes a concealment information reception unit 131, a concealment information storage unit 132, a comparison information input unit 133, a concealment index calculation unit 134, and an output unit 135.

The concealment information reception unit 131 receives the concealment information transmitted from the registration information concealment device 120, and stores the concealment information in the concealment information storage unit 132. The concealment information storage unit 132 is a device that stores the concealment information.

The comparison information input unit 133 accepts an input of biometric information (hereinafter described as comparison information) Y about an authenticated subject being used for a comparison with the registration information X. The comparison information input unit 133 may be an input device according to a kind of the comparison information Y. Further, the comparison information input unit 133 may be an input device to which a vector to be biometric information about an authenticated subject is directly input as the comparison information Y.

Note that a challenge-response method is introduced into the comparison system 100 according to the present example embodiment in order to prevent an attacker who intercepts communication between a client and a verification server from spoofing the client. Specifically, in the comparison system 100, the concealment index verification device 140 transmits a challenge different for each authentication to the concealment index calculation device 130, the concealment index calculation device 130 handles the challenge different for each authentication and calculates a response including similarity between registration information and comparison information, and thus a value of the response is changed for each authentication. In that way, even when an attacker intercepts a value of a response, the intercepted value is unusable in next authentication, and the attacker cannot generate a response associated with a different challenge, and thus a spoofed client is prevented.

The concealment index calculation unit 134 calculates, based on a plurality of templates (i.e., the concealment information acquired by concealing the registration information X), the comparison information Y, and a challenge received from the concealment index verification device 140, data (hereinafter described as a concealment index) in which an index being a value indicating similarity between each of the plurality of pieces of registration information X and the comparison information Y is concealed. At this time, the concealment index calculation unit 134 calculates the concealment index without canceling concealment of the template. A plurality of the calculated concealment indexes are transmitted to the concealment index verification device 140.

The output unit 135 receives authentication result information indicating a result of biometric authentication being transmitted from the concealment index verification device 140. Further, the output unit 135 outputs the received authentication result information to the outside of the concealment index calculation device 130.

The concealment information reception unit 131, the concealment information storage unit 132, and the output unit 135 are achieved by, for example, a central processing unit (CPU) of a computer operating according to a client program and a communication interface of the computer. For example, the CPU may read the client program from a program recording medium such as a program storage device of the computer, and operate as the concealment information reception unit 131, the concealment information storage unit 132, and the output unit 135 by using the communication interface according to the program. Further, the ID issuing unit 123 and the random number generation unit 124 are achieved by, for example, a CPU of a computer that operates according to a registration server program. For example, the CPU may read the client program from the program recording medium as described above, and operate as the ID issuing unit 123 and the random number generation unit 124 according to the program.

The concealment information storage unit 132 is achieved by a storage device included in the computer, for example.

### (Configuration of Concealment Index Verification Device 140)

The concealment index verification device 140 includes a key reception unit 141, a key storage unit 142, an acceptance range storage unit 143, a determination unit 144, and a challenge generation unit 145.

The key reception unit 141 receives the public key pk, the common concealment key sk_C, and the concealment key sk_ID for each piece of the registration information X that are transmitted from the registration information concealment device 120, and stores the keys in the key storage unit 142.

The key storage unit 142 is a storage device that stores the public key pk, the common concealment key sk_C, and the concealment key sk_ID for each piece of the registration information X.

The determination unit 144 determines, by using the keys (the public key pk, the common concealment key sk_C, and the concealment key sk_ID for each piece of the registration information X) stored in the key storage unit 142, whether an index can be acquired from each of the plurality of concealment indexes being calculated in the concealment index calculation device 130.

Note that the determination unit 144 transmits a challenge being generated by the challenge generation unit 145 to the concealment index calculation device 130 before the determination unit 144 receives each of the concealment indexes from the concealment index calculation device 130.

When an index can be acquired from each of the plurality of concealment indexes being calculated in the concealment index calculation device 130, the determination unit 144 acquires the index. Next, the determination unit 144 determines whether the registrant included in the registration information X and the authenticated subject included in the comparison information Y coincide with each other by determining whether the index acquired from each of the concealment indexes has a value within a predetermined acceptance range. Note that the predetermined acceptance range is stored in the acceptance range storage unit 143.

For example, the determination unit 144 determines that the registrant and the authenticated subject coincide with each other when the index acquired from the concealment indexes has a value within the acceptance range. Coincidence between the registrant and the authenticated subject corresponds to the registration information X and the comparison information Y being associated with each other. Further, the determination unit 144 determines that the registrant and the authenticated subject do not coincide with each other when the index acquired from the concealment indexes does not have a value within the acceptance range. Only when one determination result that the registrant and the authenticated subject coincide with each other is present, the determination unit 144 transmits, to concealment index calculation device 130, an ID and authentication result information indicating that authentication succeeds (authentication is accepted). When a determination result that the registrant and the authenticated subject coincide with each other is not present or when a plurality of the determination results of the coincidence are present, the determination unit 144 transmits, to concealment index calculation device 130, authentication result information indicating that authentication fails.

For example, when the concealment index calculation device 130 receives the authentication result information indicating that the authentication succeeds from the concealment index verification device 140, the concealment index calculation device 130 performs processing after the authentication being associated with the ID. However, a device that performs the processing after the authentication is not limited to the concealment index calculation device 130, and a device other than the client may perform the processing after the authentication being associated with the ID on a condition that the authentication result information indicating that the authentication succeeds is acquired.

The key reception unit 141, the challenge generation unit 145, and the determination unit 144 are achieved by, for example, a central processing unit (CPU) of a computer operating according to a server program and a communication interface of the computer. For example, the CPU may read the server program from a program recording medium such as a program storage device of the computer, and operate as the key reception unit 141, the challenge generation unit 145, and the determination unit 144 by using the communication interface according to the program.

The key storage unit 142 and the acceptance range storage unit 143 are achieved by a storage device included in the computer, for example.

### (Flowchart)

Subsequently, a flow of processing of the comparison system 100 will be described.

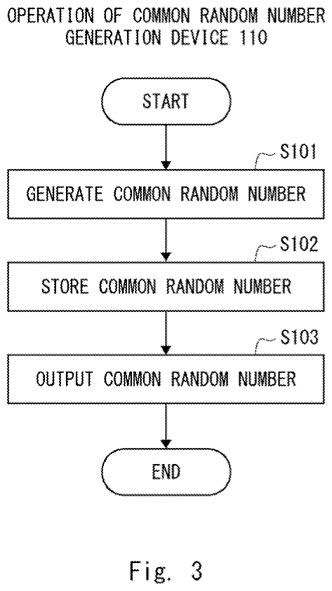

FIG. 3 is a flowchart illustrating a generation operation of a common random number in the comparison system 100. Note that a detailed description of a content that has already been described will be omitted.

First, the common random number generation device 110 generates the common random number CR in the common random number generation unit 111 (step S101). Subsequently, the common random number generation device 110 stores the common random number CR in the common random number storage unit 112 (step S102). Subsequently, the common random number generation device 110 transmits the common random number CR to the common random number input unit 122 of the registration information concealment device 120 (step S103).

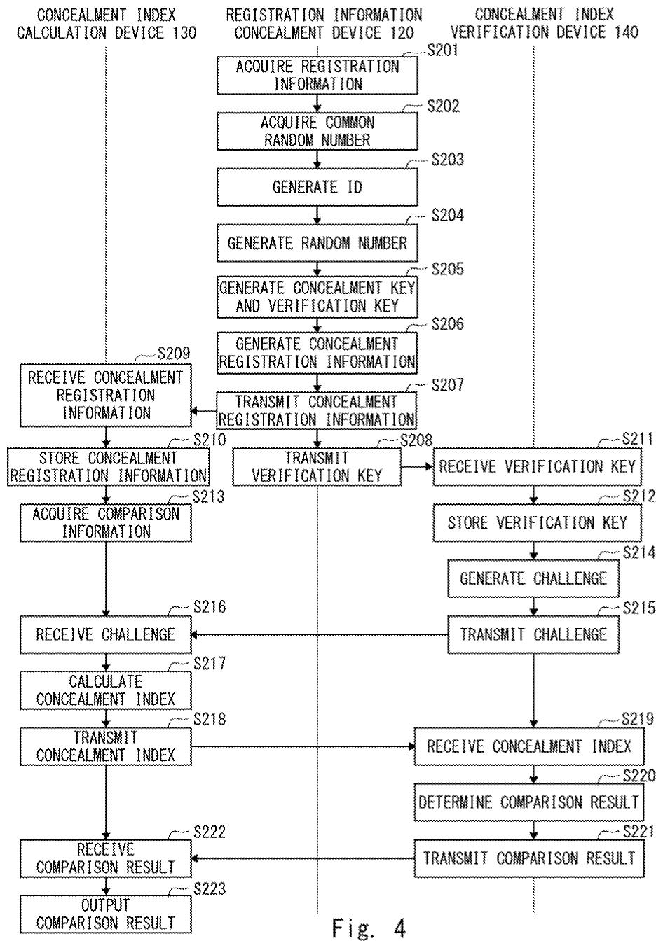

FIG. 4 is a flowchart illustrating an operation of registration processing and authentication processing in the comparison system 100. Note that a detailed description of a manner that has already been described will be omitted.

First, the registration processing is performed.

Specifically, first, the registration information X (biometric information about a registrant) is input to the registration information input unit 121 in the registration information concealment device 120 (step S201).

Next, the common random number input unit 122 receives the common random number CR being transmitted from the common random number generation device 110 (step S202).

Next, the ID issuing unit 123 issues an ID each time the registration information X is input to the registration information input unit 121 (step S203).

Next, the random number generation unit 124 generates the random number R_ID for each issued ID (step S204).

Next, the key generation unit 125 generates the secret key sk and the public key pk of a digital signature by using the common random number CR (step S205). Further, the key generation unit 125 generates the common concealment key sk_C by using the common random number CR, and also generates the concealment key sk_ID for each piece of the registration information X by using the common random number CR and the random number R_ID (step S205).

Next, the concealment unit 126 conceals the registration information X input to the registration information input unit 121 by using the secret key sk, the common concealment key sk_C, and the concealment key sk_ID associated with the registration information X, and outputs the registration information X as concealment information (step S206).

Next, the concealment unit 126 transmits the concealment information to the concealment information reception unit 131 of the concealment index calculation device 130 (step S207).

Next, the key generation unit 125 transmits, to the key reception unit 141 of the concealment index verification device 140, the public key pk, the common concealment key sk_C, and the concealment key sk_ID for each piece of the registration information X (step S208).

Next, the concealment information reception unit 131 receives the concealment information in the concealment index calculation device 130 (step S209).

Next, the concealment information storage unit 132 stores the concealment information (step S210).

Next, in the concealment index verification device 140, the key reception unit 141 receives the public key pk, the common concealment key sk_C, and the concealment key sk_ID for each piece of the registration information X that are transmitted from the registration information concealment device 120 (step S211).

Next, the key storage unit 142 stores the public key pk, the common concealment key sk_C, and the concealment key sk_ID for each piece of the registration information X (step S212).

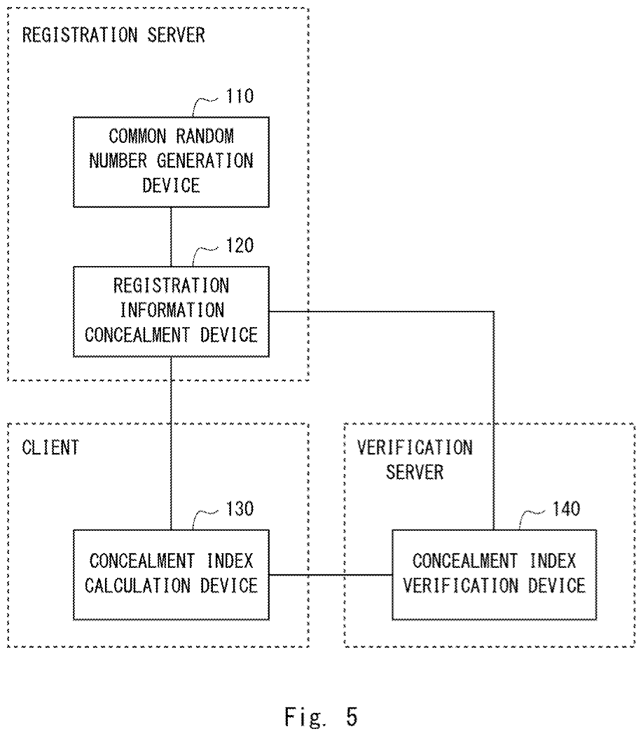

FIG. 5 is a block diagram illustrating a first application example of the comparison system 100.

In the example in FIG. 5, a registration server includes the common random number generation device 110 and the registration information concealment device 120, a client includes the concealment index calculation device 130, and a verification server includes the concealment index verification device 140. In this case, the registration server continues to hold the common random number CR, the secret key sk, the common concealment key sk_C, and the concealment key sk_ID for each piece of the registration information X.

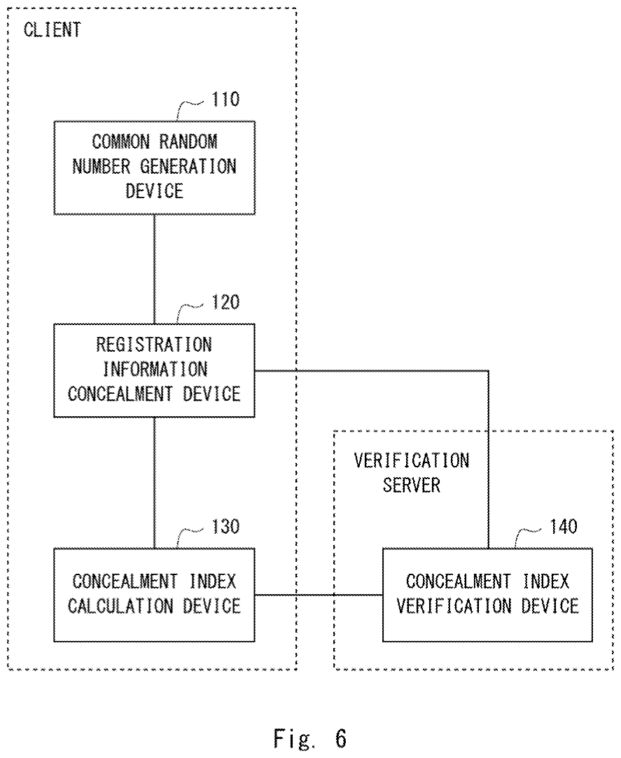

FIG. 6 is a block diagram illustrating a second application example of the comparison system 100.

In the example in FIG. 6, a client includes the common random number generation device 110, the registration information concealment device 120, and the concealment index calculation device 130, and a verification server includes the concealment index verification device 140. In this case, when the registration processing ends, the common random number CR, the secret key sk, the common concealment key sk_C, and the concealment key sk_ID for each piece of the registration information X are deleted from the client.

After the registration processing, the authentication processing is performed.

Specifically, first, the comparison information Y (biometric information about an authenticated subject) is input to the comparison information input unit 133 in the concealment index calculation device 130 (step S213).

Next, the challenge generation unit 145 generates a challenge in the concealment index verification device 140 (step S214). Further, the challenge generation unit 145 transmits the challenge to the concealment index calculation unit 134 of the concealment index calculation device 130 (step S215).

Next, the concealment index calculation unit 134 receives the challenge in the concealment index calculation device 130 (step S216).

Next, the concealment index calculation unit 134 calculates a plurality of concealment indexes, based on a plurality of templates (the concealment information acquired by concealing the registration information X), the comparison information Y, and the challenge received from the concealment index verification device 140 (step S217).

Next, the concealment index calculation unit 134 transmits the plurality of calculated concealment indexes to the determination unit 144 of the concealment index verification device 140 (step S218).

Next, in the concealment index calculation device 140, the determination unit 144 receives the plurality of concealment indexes being transmitted from the concealment index calculation device 130 (step S219).

Next, the determination unit 144 performs a comparison whether there is an index within a predetermined acceptance range in the plurality of received concealment indexes, by using the public key pk, the common concealment key sk_C, the concealment key sk_ID, and the challenge (step S220). Further, the determination unit 144 transmits a comparison result to the output unit 135 of the concealment index calculation device 130 (step S221).

Next, the output unit 135 receives the comparison result in the concealment index calculation device 130 (step S222). Next, the output unit 135 outputs the comparison result (step S223).

Hereinafter, a specific example of the authentication processing according to the present example embodiment will be described.

In the following description, it is assumed that the registration information X and the comparison information Y are both an n-dimensional vector. Then, it is assumed that each element of X is represented by X=(x_1, . . . , x_n), and each element of Y is represented by Y=(y_1, . . . , y_n). Further, it is assumed that a symbol i represents 1, . . . , n. For example, {u_i}=u_1, u_2, . . . , u_n. Furthermore, it is assumed that the number of pieces of the registration information X input at a time of registration is N. Further, it is assumed that a symbol j represents 1, . . . , N.

### First Specific Example

In the present specific example, a case where an index indicating similarity between the registration information X and the comparison information Y is an inner product of the registration information X and the comparison information Y is considered. An inner product <X, Y> of the registration information X and the comparison information Y is Σ(x_i·y_i). Hereinafter, one example of processing when an index is an inner product is exemplified.

Further, in the present specific example, a Schnorr signature is used. In the Schnorr signature, a set of the secret key sk and the public key pk=g\hat{ }sk is generated. Note that skϵZ_q (Z_q={0, 1, . . . , q−1}, q is a prime) is used (Z is a symbol representing a group of the whole integers). Further, g is a generation source of a group G of an order q. In other words, G={g_0, g_1, . . . , g_q−1}. Z_q, g, and G are shared among all devices.

Furthermore, an acceptance range θ={θ_1, . . . , θ_m} is provided to the concealment index verification device 140. The acceptance range storage unit 143 of the concealment index verification device 140 stores θ′={g\hat{ }(θ_1), . . . , g\hat{ }(θ_m)}. Note that θ′ is a group of powers of g in which each value of θ is an exponent.

Hereinafter, specific registration processing when the Schnorr signature is used will be described.

First, biometric information (i.e., registration information) {X_j} about N registrants is input to the registration information input unit 121. Next, the ID issuing unit 123 issues an ID for each piece of the biometric information. Next, the common random number generation unit 111 generates a common random number as in an equation (1) and an equation (2) below.

R_1<-\hat{ }RZ_q (1)

R_3<-\hat{ }RZ_q (2)

Further, the random number generation unit 124 generates a random number as in an equation (4) below.

(R_2_1,R_2_2, . . . ,R_2_N)<-\hat{ }RZ_q (3)

(r_1_1,r_2_1, . . . ,r_n_1,r_1_2, . . . ,r_n_N)<-\hat{ }RZ_q (4)

Next, the key generation unit 125 regards R_3 as a secret key, and generates a public key g\hat{ }(R_3). Further, a common random number {r_i_j} and random numbers R_1 and {R_2_j} are regarded as concealment keys.

The key generation unit 125 inputs the secret key and the concealment keys to the concealment unit 126. Further, the key generation unit 125 transmits an ID, the public key g\hat{ }(R_3), and the concealment keys R_1 and {R_2_j} to the key reception unit 141 of the concealment index verification device 140.

Next, the key storage unit 142 stores the ID, the public key, and the concealment keys that are received.

Next, the concealment unit 126 of the registration information concealment device 120 generates R_1·x_i_j+R_2_j·r_i+R_3, g\hat{ }(r_i_j) with respect to i=1, 2, . . . , n and j=1, 2, . . . , N, based on the input secret key, the input concealment keys, and N pieces of the registration information {X_j}. Hereinafter, templates are assumed to be {R_1·x_i_j+R_2_j·r_i_j+R3} and {g\hat{ }(r_i_j)}.

The concealment unit 126 transmits the ID and the templates to the concealment information reception unit 131 of the concealment index calculation device 130.

Next, the concealment information storage unit 132 stores the ID and the templates.

Next, specific authentication processing when the Schnorr signature is used will be described.

First, the comparison information Y is input to the comparison information input unit 133. The concealment index calculation unit 134 acquires the comparison information Y from the comparison information input unit 133, and acquires the ID and the templates from the concealment information storage unit.

Next, the concealment index calculation unit 134 calculates σ_1_j=g\hat{ }(Σr_i_j·y_i). Subsequently, the concealment index calculation unit 134 transmits the ID and associated {σ_1_j} to the determination unit 144 of the concealment index verification device 140.

Next, the concealment index verification device 140 that has received the ID and σ_1_j generates M,R<-\hat{ }RZ_q in the challenge generation unit 145, and calculates g\hat{ }(R·R_3) by using the public key g\hat{ }(R_3) stored in the key storage unit 142. Subsequently, M,g\hat{ }(R·R_3) is transmitted as a challenge to the concealment index calculation unit 134 of the concealment index calculation device.

Next, the concealment index calculation unit 134 calculates S_j=H(M,g\hat{ }r′_j). Note that H is a cryptographic hash function. Next, the concealment index calculation unit 134 calculates each value below from an equation (5), an equation (6), and an equation (7), based on the input comparison information Y and the input templates.

A_j=Σ_i(R_1·x_i_j+R_2_j·r_i_j+R_3)y_i (5)

σ_2_j=r′_j−A_j·S (6)

σ_3=g\hat{ }(R·R_3·y_i) (7)

Note that A_j is a value acquired by adding Σr_i·y_i being R_2_j times and Σy_i being R_3 times to a value acquired by multiplying the inner product <X, Y> of X and Y by R_1 times. After each value is calculated, the concealment index calculation unit 134 transmits, to the determination unit 144 of the concealment index verification device 140, ({S_j}, {σ_2_j}, σ_3) as a response including the inner product of the registration information X_j and the comparison information Y. (S_j, σ_2_j, σ_3) corresponds to the Schnorr signature having A_j as a secret key.

The determination unit 144 receives the response from the concealment index calculation unit 134. The determination unit 144 verifies N digital signatures (S_j, σ_2_j, σ_3) by using the public key g\hat{ }(R_3) stored together with the ID in the key storage unit 142, and the concealment keys R_1 and {R_2_j}. Specifically, an equation (8) below is calculated.

v_j=[{g\hat{ }(σ_2_j)}·{(σ_3)\hat{ }(S_j·R_3)}·{(σ_1_j)\hat{ }(S_j·R_2_j)}·(g\hat{ }(−r′_j))]\hat{ }(−1/R_1) (8)

The determination unit 144 confirms whether calculated v_j is included in θ′. When a value included in θ′ is not found or when a plurality of the values are found, authentication result information indicating an “authentication failure” is generated.

Further, when only one value included in θ′ is found, the determination unit 144 generates authentication result information indicating that “ID_j succeeds in authentication”.

Next, the determination unit 144 transmits the generated authentication result information to the output unit 135 of the concealment index calculation device 130. Next, the output unit 135 that has received the authentication result information outputs the authentication result information. Note that the authentication result information may be directly output from the concealment index verification device 140.

Note that, the Schnorr signature is used in the present specific example, but another digital signature method that is safe in terms of cryptography, such as a DSA signature, may be used.

### Second Specific Example

Also, in the present specific example, a case where an index indicating similarity between the registration information X and the comparison information Y is an inner product of the registration information X and the comparison information Y is considered. Hereinafter, one example of processing when an index is an inner product is exemplified.

Further, in the present specific example, the Schnorr signature is used. In the Schnorr signature, a set of the secret key sk and the public key pk=g\hat{ }sk is generated. Note that skϵZ_q (Z_q={0, 1, . . . , q−1}, q is a prime) is used (Z is a symbol representing a group of the whole integers). Further, g is a generation source of a group G of an order q. In other words, G={g_0, g_1, . . . g_q−1} Z_q, g, and G are shared among all devices.

Furthermore, an acceptance range θ={θ_1, . . . , θ_m} is provided to the concealment index verification device 140. The acceptance range storage unit 143 of the concealment index verification device 140 stores θ′={g\hat{ }(0_1), . . . , g\hat{ }(θ_m)}. Note that θ′ is a group of powers of g in which each value of θ is an exponent.

Hereinafter, specific registration processing when the Schnorr signature is used will be described.

First, biometric information (i.e., registration information) {X_j} about N registrants is input to the registration information input unit 121. Next, the ID issuing unit 123 issues an ID for each piece of the biometric information. Next, the common random number generation device 111 generates a common random number as in an equation (9) and an equation (10) below.

R_2<-\hat{ }RZ_q (9)

R_3<-\hat{ }RZ_q (10)

Further, the random number generation unit 124 generates a random number as in an equation (11) and an equation (12) below.

(R_1_1,R_1_2, . . . ,R_1_N)<-\hat{ }RZ_q (11)

(r_1_1,r_2_1, . . . ,r_n_1,r_1_2, . . . ,r_n_N)<-\hat{ }RZ_q (12)

Next, the key generation unit 125 regards R_3 as a secret key, and generates a public key g\hat{ }(R_3). Further, a common random number {r_i_j} and random numbers {R_1_j} and R_2 are regarded as concealment keys.

The key generation unit 125 inputs the secret key and the concealment keys to the concealment unit 126. Further, the key generation unit 125 transmits an ID, the public key g\hat{ }(R_3), and the concealment keys {R_1_j} and R_2 to the key reception unit 141 of the concealment index verification device 140.

Next, the key storage unit 142 stores the ID, the public key, and the concealment keys that are received.

Next, the concealment unit 126 of the registration information concealment device 120 generates R_1_j·x_i_j+R_2·r_i+R_3, g\hat{ }(r_i_j) with respect to i=1, 2, . . . , n and j=1, 2, . . . , N, based on the input secret key, the input concealment keys, and N pieces of the biometric information {X_j}. Hereinafter, templates are assumed to be {R_1_j·x_i_j+R_2·r_i+R3} and {g\hat{ }(r_i_j)}.

The concealment unit 126 transmits the ID and the templates to the concealment information reception unit 131 of the concealment index calculation device 130.

Next, the concealment information storage unit 132 stores the ID and the templates.

Next, specific authentication processing when the Schnorr signature is used will be described.

First, the comparison information Y is input to the comparison information input unit 133. The concealment index calculation unit 134 acquires the comparison information Y from the comparison information input unit 133, and acquires the ID and the templates from the concealment information storage unit.

Next, the concealment index calculation unit 134 calculates σ_1_j=g\hat{ }(Σr_i_j·y_i). Subsequently, the concealment index calculation unit 134 transmits the ID and associated {σ_1_j} to the determination unit 144 of the concealment index verification device 140.

Next, the concealment index verification device 140 that has received the ID and σ_1_j generates M,R<-\hat{ }RZ_q in the challenge generation unit 145, and calculates g\hat{ }(R·R_3) by using the public key g\hat{ }(R_3) stored in the key storage 30 unit 142. Subsequently, M,g\hat{ }(R·R_3) is transmitted as a challenge to the concealment index calculation unit 134 of the concealment index calculation device.

Next, the concealment index calculation unit 134 calculates S_j=H(M,g\hat{ }r′_j). Note that H is a cryptographic hash function. Next, the concealment index calculation unit 134 calculates each value below from an equation (13), an equation (14), and an equation (15), based on the input comparison information Y and the input templates.

A_j=Σ_i(R_1_j·x_i_j+R_2·r_i_j+R_3)·y_i (13)

σ_2_j=r′_j−A_j·S (14)

σ_3=g\hat{ }(R·R_3·y_i) (15)

Note that A_j is a value acquired by adding Σr_i·y_i being R_2 times and Σy_i being R_3 times to a value acquired by multiplying the inner product <X, Y> of X and Y by R_1_j times. After each value is calculated, the concealment index calculation unit 134 transmits, to the determination unit 144 of the concealment index verification device 140, ({S_j}, {σ_2_j}, σ_3) as a response including the inner product of the registration information X_j and the comparison information Y. (S_j, σ_2_j, σ_3) corresponds to the Schnorr signature having A_j as a secret key.

The determination unit 144 receives the response from the concealment index calculation unit 134. The determination unit 144 verifies N digital signatures (S_j, σ_2_j, σ_3) by using the public key g\hat{ }(R_3) stored together with the ID in the key storage unit 142, and the concealment keys {R_1_j} and R_2. Specifically, an equation (16) below is calculated.

v_j=[{g\hat{ }(σ_2_j)}·{(σ_3)\hat{ }(S_j·R_3)}·{(σ_1_j)\hat{ }(S_j·R_2)}·(g\hat{ }(−r′_j))]\hat{ }(−1/R_1_j) (16)

The determination unit 144 confirms whether calculated v_j is included in θ′. When a value included in θ′ is not found or when a plurality of the values are found, authentication result information indicating an “authentication failure” is generated.

Further, when only one value included in θ′ is found, the determination unit 144 generates authentication result information indicating that “ID_j succeeds in authentication”.

Next, the determination unit 144 transmits the generated authentication result information to the output unit 135 of the concealment index calculation device 130. Next, the output unit 135 that has received the authentication result information outputs the authentication result information. Note that the authentication result information may be directly output from the concealment index verification device 140.

Note that, the Schnorr signature is used in the present specific example, but another digital signature method that is safe in terms of cryptography, such as a DSA signature, may be used.

In this way, the comparison system 100 according to the second example embodiment makes some of concealment keys used for generating each template uniform, and can thus reduce the number of pieces of data being held by the client and the number of keys being held by the verification server and reduce the number of times of exponentiation and a communication amount of the client and the verification server, as compared to when some of concealment keys are not made uniform. In other words, the comparison system 100 according to the second example embodiment can perform efficient 1:N authentication.

Note that, in the comparison system 100 according to the second example embodiment, encrypted registration information is stored as a template in the client, and thus damage at occurrence of data leakage can be further reduced than when the encrypted registration information is stored in the server. In other words, the comparison system 100 according to the second example embodiment can perform efficient 1:N authentication while improving security performance.

Note that the comparison system 100 can be appropriately changed to a configuration that performs only the registration processing. For example, the comparison system 100 may be formed of the common random number generation device 110, the registration information concealment device 120, a concealment index calculation device 130a, and a concealment index verification device 140a. The concealment index calculation device 130a is a device associated with the concealment index calculation device 130, and includes only the concealment information reception unit 131 and the concealment information storage unit 132. The concealment index verification device 140a is a device associated with the concealment index verification device 140, and includes only the key reception unit 141 and the key storage unit 142.

Further, the comparison system 100 can be appropriately changed to a configuration that performs only the authentication processing. For example, the comparison system 100 may be formed of the concealment index calculation device 130a and the concealment index verification device 140a. The concealment index calculation device 130a is a device associated with the concealment index calculation device 130, and includes only the concealment information storage unit 132, the comparison information input unit 133, the concealment index calculation unit 134, and the output unit 135. The concealment index verification device 140a is a device associated with the concealment index verification device 140, and includes only the key storage unit 142, the acceptance range storage unit 143, the determination unit 144, and the challenge generation unit 145.

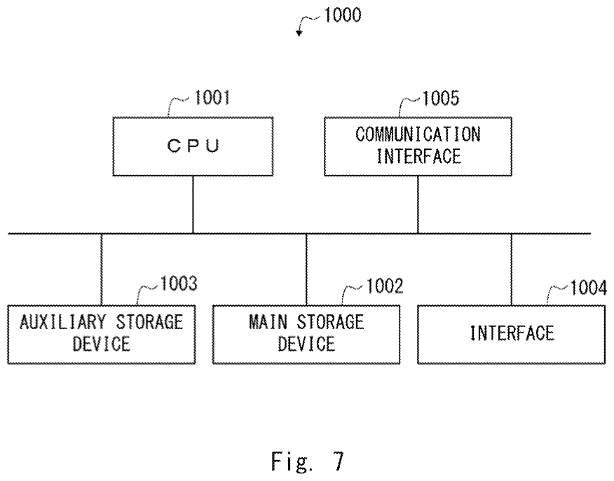

FIG. 7 is a block diagram illustrating an outline of a computer that achieves a client and a server to which the comparison systems according to the first and second example embodiments are applied. Hereinafter, the description is given with reference to FIG. 7, and a computer used as a client and a computer used as a server are different computers.

A computer 1000 includes a CPU 1001, a main storage device 1002, an auxiliary storage device 1003, an interface 1004, and a communication interface 1005.

An operation of the computer 1000 that achieves a client is stored in the auxiliary storage device 1003 in a form of a client program. The CPU 1001 reads the client program from the auxiliary storage device 1003, develops the client program in the main storage device 1002, and performs the operation of the client described in the example embodiments and the specific examples thereof described above according to the client program.

An operation of the computer 1000 that achieves a server is stored in the auxiliary storage device 1003 in a form of a server program. The CPU 1001 reads the server program from the auxiliary storage device 1003, develops the server program in the main storage device 1002, and performs the operation of the server described in the example embodiments and the specific examples thereof described above according to the server program.

The auxiliary storage device 1003 is an example of a non-transitory tangible medium. Other examples of the non-transitory tangible medium include a magnetic disk connected via the interface 1004, a magneto-optical disk, a compact disk read only memory (CD-ROM), a digital versatile disk read only memory (DVD-ROM), a semiconductor memory, and the like. Further, when a program is distributed to the computer 1000 through a communication line, the computer 1000 that receives the distribution may develop the program in the main storage device 1002 and operate according to the program.

Further, a part or the whole of each of the components of the client may be achieved by general-purpose or dedicated circuitry, a processor, and the like, or achieved by a combination thereof. A part or the whole of each of the components may be formed by a single chip or formed by a plurality of chips connected to one another via a bus. A part or the whole of each of the components may be achieved by a combination of the above-described circuitry and the like and a program. This point is also similar to the server.

A part or the whole of the above-mentioned example embodiments may also be described in Supplementary Notes below, which is not limited thereto.

### (Supplementary Note 1)

A comparison system including:
a common random number generation means for generating a common random number;
an identification information generation means for generating a plurality of pieces of identification information being unique for each of a plurality of pieces of registration information being a plurality of pieces of biometric information about a plurality of registrants;
a key generation means for generating a common key being common to each of the plurality of pieces of registration information by using the common random number, and also generating a plurality of unique keys being unique for each of the plurality of pieces of registration information by using the plurality of pieces of identification information;
a concealment means for generating a plurality of pieces of concealment information in which each of the plurality of pieces of registration information is concealed by using the common key and the plurality of unique keys;
a client; and
a verification server, wherein
the client includes a concealment index calculation means for calculating a plurality of concealment indexes representing a similarity degree between comparison information being biometric information about an authenticated subject, and each of the plurality of pieces of concealment information, and
the verification server includes a determination means for generating a plurality of indexes acquired by decrypting each of the plurality of concealment indexes by using the common key and the plurality of unique keys, and also performing authentication of the comparison information, based on whether any of the plurality of indexes indicates a value within a predetermined range.

### (Supplementary Note 2)

The comparison system according to Supplementary Note 1, wherein the determination means accepts authentication of the comparison information when any one of the plurality of indexes indicates a value within the predetermined range.

### (Supplementary Note 3)

The comparison system according to Supplementary Note 1 or 2, wherein
each of the unique keys is formed of a secret key and a public key, and
the key generation means transmits a secret key of each of the unique keys to the concealment means, and transmits a public key of each of the unique keys to the verification server.

### (Supplementary Note 4)

The comparison system according to any one of Supplementary Notes 1 to 3, wherein
the verification server further includes a challenge generation means for generating a challenge signal for each piece of the comparison information, and transmitting the challenge signal to the client, and,
in the client, the concealment index calculation means is configured to calculate the plurality of concealment indexes as a response signal being associated with the challenge signal.

### (Supplementary Note 5)

The comparison system according to any one of Supplementary Notes 1 to 4, wherein the comparison information and the plurality of pieces of registration information are both represented by a vector.

### (Supplementary Note 6)

The comparison system according to any one of Supplementary Notes 1 to 5, wherein, in the client, the concealment index calculation means calculates the plurality of concealment indexes by an inner product of the comparison information and each of the plurality of pieces of concealment information.

### (Supplementary Note 7)

The comparison system according to any one of Supplementary Notes 1 to 6, wherein at least the identification information generation means, the key generation means, and the concealment means are provided in the client.

### (Supplementary Note 8)

The comparison system according to any one of Supplementary Notes 1 to 6, wherein at least the identification information generation means, the key generation means, and the concealment means are provided in a registration server different from the client and the verification server.

### (Supplementary Note 9)

A comparison method including:
a common random number generation step of generating a common random number;
an identification information generation step of generating a plurality of pieces of identification information being unique for each of a plurality of pieces of registration information being a plurality of pieces of biometric information about a plurality of registrants;
a key generation step of generating a common key being common to each of the plurality of pieces of registration information by using the common random number, and also generating a plurality of unique keys being unique for each of the plurality of pieces of registration information by using the plurality of pieces of identification information;
a concealment step of generating a plurality of pieces of concealment information in which each of the plurality of pieces of registration information is concealed by using the common key and the plurality of unique keys;
in a client, a concealment index calculation step of calculating a plurality of concealment indexes representing a similarity degree between comparison information being biometric information about an authenticated subject, and each of the plurality of pieces of concealment information; and,
in a verification server, a determination step of generating a plurality of indexes acquired by decrypting each of the plurality of concealment indexes by using the common key and the plurality of unique keys, and also performing authentication of the comparison information, based on whether any of the plurality of indexes indicates a value within a predetermined range.

### (Supplementary Note 10)

A non-transitory computer readable medium storing a comparison program causing a computer to execute:
common random number generation processing of generating a common random number;
identification information generation processing of generating a plurality of pieces of identification information being unique for each of a plurality of pieces of registration information being a plurality of pieces of biometric information about a plurality of registrants;
key generation processing of generating a common key being common to each of the plurality of pieces of registration information by using the common random number, and also generating a plurality of unique keys being unique for each of the plurality of pieces of registration information by using the plurality of pieces of identification information;
concealment processing of generating a plurality of pieces of concealment information in which each of the plurality of pieces of registration information is concealed by using the common key and the plurality of unique keys;
in a client, concealment index calculation processing of calculating a plurality of concealment indexes representing a similarity degree between comparison information being biometric information about an authenticated subject, and each of the plurality of pieces of concealment information; and,
in a verification server, determination processing of generating a plurality of indexes acquired by decrypting each of the plurality of concealment indexes by using the common key and the plurality of unique keys, and also performing authentication of the comparison information, based on whether any of the plurality of indexes indicates a value within a predetermined range.

Although the invention of the present application has been described with reference to the example embodiments, it should be understood that the invention of the present application is not limited to the above-described example embodiments. Various modifications that can be understood by those skilled in the art can be made to the configuration and the details of the invention of the present application within the scope of the invention of the present application.

### REFERENCE SIGNS LIST

100 COMPARISON SYSTEM
110 COMMON RANDOM NUMBER GENERATION DEVICE
111 COMMON RANDOM NUMBER GENERATION UNIT
112 COMMON RANDOM NUMBER STORAGE UNIT
120 REGISTRATION INFORMATION CONCEALMENT DEVICE
121 REGISTRATION INFORMATION INPUT UNIT
122 COMMON RANDOM NUMBER INPUT UNIT
123 ID ISSUING UNIT
124 RANDOM NUMBER GENERATION UNIT
125 KEY GENERATION UNIT
126 CONCEALMENT UNIT
130 CONCEALMENT INDEX CALCULATION DEVICE
131 CONCEALMENT INFORMATION RECEPTION UNIT
132 CONCEALMENT INFORMATION STORAGE UNIT
133 COMPARISON INFORMATION INPUT UNIT
134 CONCEALMENT INDEX CALCULATION UNIT
135 OUTPUT UNIT
140 CONCEALMENT INDEX VERIFICATION DEVICE
141 KEY RECEPTION UNIT
142 KEY STORAGE UNIT
143 ACCEPTANCE RANGE STORAGE UNIT
144 DETERMINATION UNIT
145 CHALLENGE GENERATION UNIT
1000 COMPUTER
1002 MAIN STORAGE DEVICE
1003 AUXILIARY STORAGE DEVICE
1004 INTERFACE
1005 COMMUNICATION INTERFACE

What is claimed is:

1. A comparison system comprising:
at least one first memory storing program instructions; and
at least one first processor coupled to the at least one first memory, the at least one first processor being configured to execute the program instructions stored in the at least one first memory to:
generate a common random number;
generate a plurality of pieces of identification information being unique for each of a plurality of pieces of registration information being a plurality of pieces of biometric information about a plurality of registrants;
generate a common key being common to each of the plurality of pieces of registration information by using the common random number, and also generate a plurality of unique keys being unique for each of the plurality of pieces of registration information by using the plurality of pieces of identification information; and
generate a plurality of pieces of concealment information in which each of the plurality of pieces of registration information is concealed by using the common key and the plurality of unique keys,
the comparison system further comprising:
a client; and
a verification server, wherein
the client comprises:
at least one second memory storing program instructions; and
at least one second processor coupled to the at least one second memory, the at least one second processor being configured to execute the program instructions stored in the at least one second memory to:
calculate a plurality of concealment indexes representing a similarity degree between comparison information being biometric information about an authenticated subject, and each of the plurality of pieces of concealment information, and
the verification server comprises:
at least one third memory storing program instructions; and
at least one third processor coupled to the at least one third memory, the at least one second processor being configured to execute the program instructions stored in the at least one third memory to
generate a plurality of indexes acquired by decrypting each of the plurality of concealment indexes by using the common key and the plurality of unique keys, and also perform authentication of the comparison information, based on whether any of the plurality of indexes indicates a value within a predetermined range.

2. The comparison system according to claim 1, wherein in the authentication of the comparison information, the authentication is accepted when any one of the plurality of indexes indicates a value within the predetermined range.

3. The comparison system according to claim 1, wherein
each of the unique keys is formed of a secret key and a public key, and
in the generation of the key, a secret key of each of the unique keys is used to generate the concealment information, and a public key of each of the unique keys is transmitted to the verification server.

4. The comparison system according to claim 1, wherein
in the verification server, the at least one third processor is further configured to execute the program instructions stored in the at least one third memory to
generate a challenge signal for each piece of the comparison information, and transmit the challenge signal to the client, and
in the client, in the calculation of the concealment index, the plurality of concealment indexes are calculated as a response signal being associated with the challenge signal.

5. The comparison system according to claim 1, wherein the comparison information and the plurality of pieces of registration information are both represented by a vector.

6. The comparison system according to claim 1, wherein in the client, in the calculation of the concealment index, the plurality of concealment indexes are calculated by an inner product of the comparison information and each of the plurality of pieces of concealment information.

7. The comparison system according to claim 1, wherein at least the generation of the identification information, the generation of the key, and the generation of the concealment information are performed in the client.

8. The comparison system according to claim 1, wherein at least the generation of the identification information, the generation of the key, and the generation of the concealment information are performed in a registration server different from the client and the verification server.

9. A comparison method comprising:
generating a common random number;
generating a plurality of pieces of identification information being unique for each of a plurality of pieces of registration information being a plurality of pieces of biometric information about a plurality of registrants;
generating a common key being common to each of the plurality of pieces of registration information by using the common random number, and also generating a plurality of unique keys being unique for each of the plurality of pieces of registration information by using the plurality of pieces of identification information;
generating a plurality of pieces of concealment information in which each of the plurality of pieces of registration information is concealed by using the common key and the plurality of unique keys;
in a client, calculating a plurality of concealment indexes representing a similarity degree between comparison information being biometric information about an authenticated subject, and each of the plurality of pieces of concealment information; and
in a verification server, generating a plurality of indexes acquired by decrypting each of the plurality of concealment indexes by using the common key and the plurality of unique keys, and also performing authentication of the comparison information, based on whether any of the plurality of indexes indicates a value within a predetermined range.

10. A non-transitory computer readable medium storing a comparison program causing a computer to execute:
common random number generation processing of generating a common random number;
identification information generation processing of generating a plurality of pieces of identification information being unique for each of a plurality of pieces of registration information being a plurality of pieces of biometric information about a plurality of registrants;
key generation processing of generating a common key being common to each of the plurality of pieces of registration information by using the common random number, and also generating a plurality of unique keys being unique for each of the plurality of pieces of registration information by using the plurality of pieces of identification information;
concealment processing of generating a plurality of pieces of concealment information in which each of the plurality of pieces of registration information is concealed by using the common key and the plurality of unique keys;
in a client, concealment index calculation processing of calculating a plurality of concealment indexes representing a similarity degree between comparison information being biometric information about an authenticated subject, and each of the plurality of pieces of concealment information; and
in a verification server, determination processing of generating a plurality of indexes acquired by decrypting each of the plurality of concealment indexes by using the common key and the plurality of unique keys, and also performing authentication of the comparison information, based on whether any of the plurality of indexes indicates a value within a predetermined range.
